(19) United States
(12) Patent Application Publication
(10) Pub. No.: US 2004/0082297 A1
(43) Pub. Date: Apr. 29, 2004

(54) Test protocols for wireless test

(76) Inventors: Mark A. Stambaugh, Post Falls, ID (US); Steven M. Falahee, Liberty Lake, WA (US); Savitha Muthanna, Veradale, WA (US); David Connolly, Spokane, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/281,592

(22) Filed: Oct. 28, 2002

(51) Int. Cl. H04B 17/00

(52) U.S. Cl. 455/67.11; 702/108

(57) ABSTRACT

Accelerated test of wireless devices. During normal device operation, protocol-specified delays in acknowledging received messages have the effect of reducing channel congestion, for example by piggybacking acknowledgements. When operating in a test environment, these protocol-specified delays are reduced or eliminated, thus reducing test time and increasing tester throughput. A first embodiment reduces or eliminates these protocol-specified delays in the tester. A second embodiment reduces or eliminates these protocol-specified delays in both the tester and the device under test.

### BACKGROUND OF THE INVENTION

1. Field of the Invention

The present invention pertains to the art of testing digital wireless devices. In particular, it deals with wireless communications protocols in the testing environment.

2. Art Background

Digital wireless devices are based on communications protocols. A vital part of the manufacturing of a digital wireless device is testing. One phase of this testing, usually near the end of the test process, is the verification of the device's overall function by having a tester exercise it using the device's standard protocols.

Commonly used wireless protocols, such as the 1×EV-DO, also known as the CDMA 2000 High Rate Packet Data Air Interface Specification as part of the 3GPP2 protocols are designed in an attempt to minimize transmissions by the device, which results in keeping the transmission medium uncongested. In such protocols, when a device receives a message, the protocol specifies that the receiver wait a period of time before sending a header-only message in the hope that the acknowledgement may be piggybacked on to an outgoing message. In one set of protocols, this wait period is 200 milliseconds. Thus, when a message is received, the receiver waits 200 milliseconds before sending an acknowledgement, unless the acknowledgement can be piggybacked onto other traffic to be transmitted.

In the real world, this protocol-specified delay results in the reduction of transmitted traffic. In the test environment, however, this delay has quite a different effect.

In the test environment, these protocol-specified delays represent dead time, extending the time required to test a device. In the testing business, as in many others, time is money, and there is always pressure to test more devices in less time.

### SUMMARY OF THE INVENTION

Protocol-specified delays are shortened or eliminated, reducing the time required to test a device. In a first embodiment of the invention, protocol-specified delays are shortened or eliminated in the test system. In a second embodiment of the invention, protocol-specified delays are shortened or eliminated both in the test system and the device under test.

### BRIEF DESCRIPTION OF THE DRAWINGS

The present invention is described with respect to particular exemplary embodiments thereof and reference is made to the drawings in which:

FIG. 1 shows a message sequence according to a standard protocol, and

FIG. 2 shows a message sequence according to a testing version of the protocol.

### DETAILED DESCRIPTION

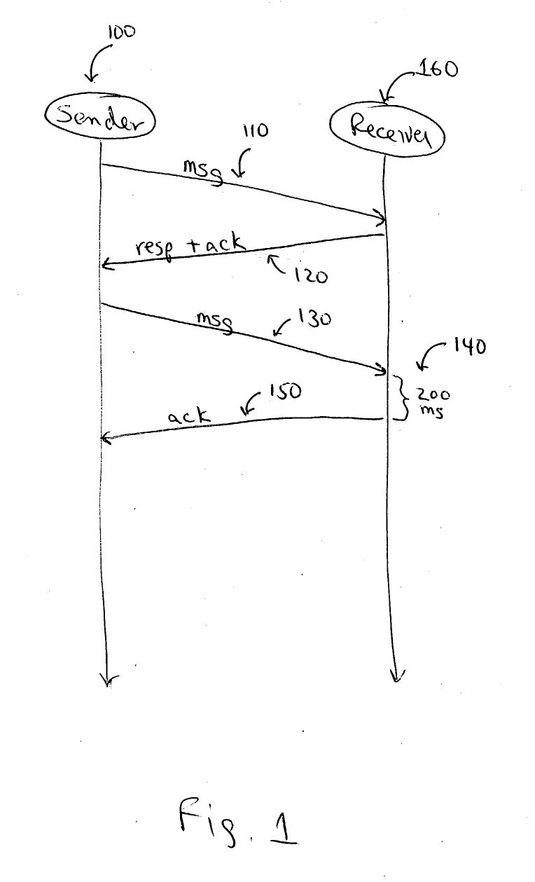

A common goal of protocols designed for use in wireless devices is to maximize the availability of channel resources by reducing traffic as much as practicable. Such a protocol is shown in FIG. 1. In this figure, time flows from top to bottom. Sender 100 sends a reliable message 110 to receiver 160. According to the protocol, receiver 160 in this example sends a response 120 back to sender 100; response 120 contains an acknowledgement of message 110. Sender 100 sends a second message 130 to receiver 160. This message does not require a response. According to the protocol, receiver 160 waits a period of time 140, in this example 200 milliseconds, before sending a header-only acknowledgement 150 of message 130. In actual operation of the device, this protocol-specified delay has the effect of reducing channel traffic.

In the test environment, however, this protocol-specified delay introduces dead time into the device test cycle. For example, in a test sequence, if 14 messages generate delayed acknowledgements, a total of 14 times 200 milliseconds or 2.8 seconds of dead time is present in the test sequence.

According to the present invention, the wireless device is operated in a test mode in which protocol-specified delays are reduced or eliminated, thus reducing the overall time required to test a device.

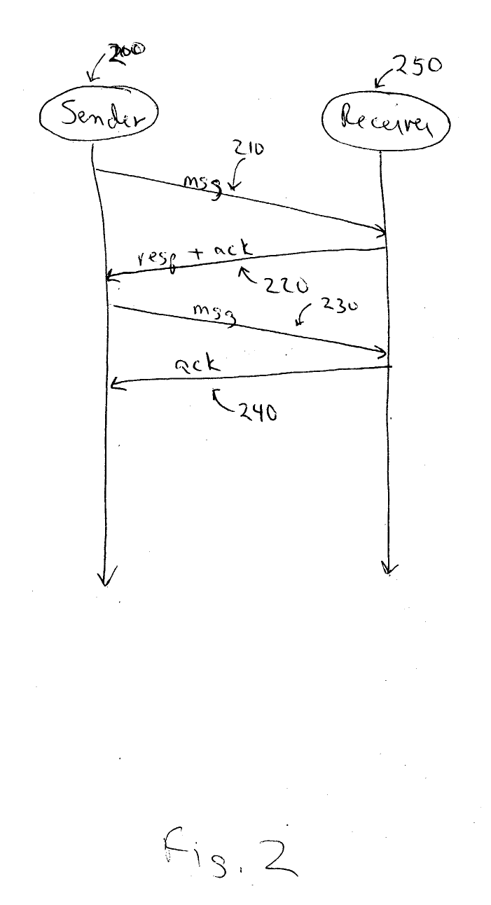

This is shown in FIG. 2. By reducing or eliminating protocol-specified delays, test time is reduced and the number of devices which can be tested in a period of time is increased. Sender 200 sends a reliable message 210 to receiver 250. According to the protocol, receiver 250 in this example sends a response 220 back to sender 200; response 220 contains an acknowledgement of message 210. Sender 200 sends a second message 230 to receiver 250. This message does not require a response. According to the protocol, receiver 250 should wait a period of time, in this example 200 milliseconds, before sending a header-only acknowledgement of message 230. In accordance with the present invention, however, the specifications of the protocol are violated, and ack 240 is sent immediately.

In a first embodiment of the invention, reduction or elimination of protocol-specified delays is practiced by the testing equipment, leaving the device under test (DUT) unchanged. This embodiment accelerates testing by reducing or eliminating protocol-specified delays in the test system.

While it is preferable to eliminate protocol based delays, the characteristics of the device under test may require a minimum time between the tester receiving a message and transmitting a reply such as an acknowledgement. These minimum delays may be imposed by characteristics such as the turn-around time of transceivers, or the settling time of their frequency determining subsystems.

In a second embodiment of the present invention, the device under test is modified to have a normal operating mode in which protocol-specified delays are applied, and a testing mode in which protocol-specified delays are reduced or eliminated. In this embodiment, it is necessary to switch the device under test from a normal operating mode to a testing mode in which protocol-specified delays are reduced or eliminated. It may be desirable to begin testing of the device under test in its normal mode, to verify that it produces the proper protocol-specified delays. Once this operation has been verified, the tester may switch the device under test to the testing mode, reducing or eliminating protocol-specified delays. This switching may be performed through direct electrical connection to the device under test, such as the use of electrical contacts provided for test purposes, or it may be done through an extension of the communications protocol. It should also be noted that while the device under test is a wireless device, the connection to the tester may be wireless, through the use of antennas, or in the form of a direct electrical connection carrying RF signals between the tester and the wireless device under test.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. In a system for testing wireless digital devices comprising a tester and a device under the test, the tester performing tests on the device under test under a specified communications protocol, the improvement comprising reducing or eliminating protocol-specified delays between the time information is received and a response is transmitted.

2. The system of claim 1 where the reduction of protocol-specified delays is implemented in the tester.

3. The system of claim 1 where the reduction of protocol-specified delays is implemented in the device under test.

4. The system of claim 1 where the reduction of protocol-specified delays is implemented in both the tester and the device under test.

5. The system of claim 1 where one of the protocol-specified delays is the delay between message reception and acknowledgement.

6. A wireless digital device adapted to be tested in a tester under a communications protocol comprising:
a first normal operating mode compliant with the communications protocol,
a second testing mode wherein communications protocol based delays are reduced or eliminated, and
means responsive to the tester for switching between the first normal operating mode and the second testing mode.

7. The device of claim 6 where one of the protocol-specified delays is the delay between message receipt and acknowledgement.
